(19) United States
(12) Patent Application Publication
(10) Pub. No.: US 2015/0274932 A1
(43) Pub. Date: Oct. 1, 2015

(54) USE OF BIOCIDES AS FLAME RETARDANTS

(71) Applicant: BAYER CROPSCIENCE AG, Monheim (DE)

(72) Inventors: Jens Hepperle, Koeln (DE); Karin Horn, Solingen (DE); Ronald Vermeer, Monheim (DE)

(21) Appl. No.: 14/428,724

(22) PCT Filed: Sep. 13, 2013
(86) PCT No.: PCT/EP2013/069026

§ 371 Date: Mar. 17, 2015

(30) Foreign Application Priority Data
Sep. 20, 2012 (EP) 12185232.1
Mar. 6, 2013 (EP) 13157918.7

(51) Int. Cl. C08K 5/315; A47C 29/00; A01M 3/00; E04B 1/72; C08K 5/3445; A01N 53/00

(52) U.S. Cl. CPC C08K 5/315; C08K 5/3445; A01N 53/00; A01M 3/002; E04B 1/72; A47C 29/006

(57) ABSTRACT

The present invention relates to the use of biocides as flame retardants.

The present invention relates to the use of biocides as flame retardants.

Flame retardants are chemicals used in polymers such as thermoplastics and thermosets; textiles and coatings to inhibit or resist the spread of fire. These can be separated into several different classes of chemicals:
Minerals (such as aluminium hydroxide ATH, magnesium hydroxide MDH, huntite and hydromagnesite, various hydrates, red phosphorus, and boron compounds, mostly borates);
Organohalogen compounds. These include organochlorines such as, chlorendic acid derivatives and chlorinated paraffins; organobromines such as decabromodiphenyl ether (decaBDE), decabromodiphenyl ethane (a replacement for decaBDE), polymeric brominated compounds such as brominated polystyrenes, brominated carbonate oligomers (BCOs), brominated epoxy oligomers (BEOs), tetrabromophthalic anyhydride, tetrabromobisphenol A (TBBPA) and hexabromocyclododecane (HBCD). Most but not all halogenated flame retardants are used in conjunction with a synergist to enhance their efficiency. Antimony trioxide is widely used but other forms of antimony such as the pentoxide and sodium antimonate are also used;
Organophosphorus compounds such as organophosphates, tris(2,3-dibromopropyl) phosphate, TPP, RDP, BPADP, tri-o-cresyl phosphate, phosphonates such as DMMP and phosphinates. There is also an important class of flame retardants that contain both phosphorus and halogen, examples of such are the chlorophosphates like TMCP and TDCP.

In general, a biocide is considered to be a chemical substance which can deter, render harmless, or exert a controlling effect on any harmful organism by chemical means. Biocides are commonly used in medicine, agriculture, forestry and industry.

Mirex (Dechlorane Plus, IUPAC name: 1,1a,2,2,3,3a,4,5,5,5a,5b,6-dodecachlorooctahydro-1H-1,3,4-(methanetriyl)cyclobuta[cd]pentalene) is a chlorinated hydrocarbon biocide that was commercialized as an insecticide and in 1978 banned by the Stockholm Convention because of its impact on the environment (toxicity to marine invertebrates). Mirex is a stomach insecticide. The insecticidal use was focused on Southeastern United States to control the imported fire ants. Mirex is also known as an additive chlorinated flame retardant.

Endosulfan (IUPAC name: 6,7,8,9,10,10-Hexachloro-1,5,5a,6,9,9a-hexahydro-6,9-methano-2,4,3-benzodioxathiepine-3-oxide) is another known chlorinated hydrocarbon biocide used in agriculture around the world to control insect pests including whiteflies, aphids, leafhoppers, Colorado potato beetles and cabbage worms. Endosulfan became a highly controversial agrichemical due to its acute toxicity, potential for bioaccumulation and role as an endocrine disruptor. Because of its threats to human health and the environment, a global ban on the manufacture and use of Endosulfan was negotiated under the Stockholm Convention in April 2011. The ban will take effect in mid 2012, with certain uses exempted for 5 additional years. Also endosulfan is known to be a flame retardant.

Another chlorinated hydrocarbon known to be an insecticide is Dieldrin (IUPAC name: 1aR,2R,2aS,3S,6R,6aR,7S,7aS)-3,4,5,6,9,9-hexachloro-1a,2,2a,3,6,6a,7,7a-octahydro-2,7:3,6-dimethanonaphtho[2,3-b]oxirene). Long-term exposure to Dieldrin has proven toxic to a very wide range of animals including humans, far greater than to the original insect targets. For this reason it is now banned in most of the world. Dieldrin is known to be a flame retardant.

Other known insecticides and flame-retardants besides Mirex, Endosulfan and Dieldrin are Endrin, Aldrin and Chlordane all of which share a chlorinated norbornene moiety. Except Mirex all of these biocides are listed under Proposition 65, a list of chemicals that are known to cause cancer, birth defects, or other reproductive harm.

U.S. Pat. No. 4,324,910 relates to substituted urea compounds containing at least one 2,2,2-trichloro-1-hydroxyethyl group which is useful as a flame retardant for polymers such a polyurethane. In addition, these compounds are described U.S. Pat. No. 4,324,910 as useful pesticides, herbicides, fungicides and bactericides.

Anne Schipper et al. (Fire and Materials, Vol. 19, 61-64 (1995)) discloses data in regard to the correlation between the chlorine content of a compound and its suppressing effect on the combustion process. Data has been collected with compounds such as 3-6-dichloro-2-methoxybenzoic acid (herbicide Dicamba), 4-chloro-2-methylphenoxy acetic acid (herbicide MCPA), 1,3-dichloropopene (foil fumigant) and hexachlorocyclohexane (insecticide Lindane).

GB 1 255 198 A discloses halogenated aryl esters of phosphoric acid suitable as pesticides such as insecticides, acaricides and bactericides. It is also disclosed that the compounds may be used as difficulty combustible dielectrics and flame-retarding agents for plastics, as additives for lacquers and as impregnating agents for textiles.

JP H08 26907 A discloses an emulsifiable concentrated agrochemical preparation having flame retarding properties consisting of a rosin plasticizer, a surfactant, a polar solvent and an agrochemical compound such as Triazimenol, Propiconazole, Cypermethrin, Chloropyrifos etc. JP H08 26907 does also discuss the use of agrochemical compounds for the EC formulation which do not comprise a halogenic group such as e.g. Ethofumesate, Fenamiphos etc. Furthermore, it is generally known that a rosin plasticizer has flame-retardant properties. In summary, this publication does not disclose that the agrochemical compounds per se have flame retarding properties but rather discloses that the flame retarding properties of the EC formulation can be traced back to the rosin plasticizer (and the lack of organic solvents).

It was an objective of the present invention to provide a biocide that can deter, render harmless, or exert a controlling effect on any harmful organism by chemical means and that are useful as flame retardants. Surprisingly it has been found that certain biocides can be used as flame-retardants. In particular, it has been found that a biocide comprising at least one halogen moiety can be used as a flame retardant with the proviso that the biocide is not selected from the group of Mirex, Endosulfan, Dieldrin, Endrin, Aldrin, Chlordane, Dicamba, Lindane, MCPA, 1,3-dichloropropene, a substituted urea compound containing at least one 2,2,2-trichloro-1-hydroxyethyl group and a halogenated aryl di-ester compound of phosphoric acid. In a preferred embodiment of the invention biocides are used as flame-retardants that do not comprise a compound comprising a chlorinated norbornene moiety, Dicamba, Lindane, MCPA, 1,3-dichloropropene, a substituted urea compound containing at least one 2,2,2-trichloro-1-hydroxyethyl group and/or a halogenated aryl di-ester compound of phosphoric acid.

The term “biocide” according to the invention as used herein shall refer to a chemical substance comprising at least one halogen group (such as chlorine, bromine, iodine, fluorine) which can deter, render harmless, or exert a controlling effect on any harmful organism by chemical means. A biocide according to the invention can be a pesticide which include insecticides, fungicides, herbicides, safeners, plant growth regulators, algicides, molluscicides, miticides, nematicides, omnicides and rodenticides. A biocide can also be an antimicrobial/antiviral chemical substance which includes germicides, antibiotics, antibacterials, antivirals, antifungals, antiprotozoals and antiparasites.

In another preferred embodiment of the invention biocides are used as flame retardants that comprise at least one atom selected from the group of bromine, chlorine and iodine. In an even more preferred embodiment biocides are used as flame retardants that comprise at least one atom selected from the group of bromine and chlorine. In another preferred embodiment biocides are uses as flame retardants that comprise at least one bromine atom, even more preferred are biocides with at least two bromine atoms.

In a preferred embodiment of the invention, a biocide is defined to be a herbicide, insecticide, nematicide, rodenticide and/or a fungicide comprising at least one halogen group. In an even more preferred embodiment of the invention the biocide is an insecticide. In an even more preferred embodiment of the invention the insecticide is not classified as a toxicity class 1 compound (preferably at the time of filing this application) according to the US Environmental Protection Agency toxicity classification system.

The term “flame retardant” according to the invention as used herein shall refer to a characteristic whereby the addition of a “flame retardant” to a base material may decrease the combustibility of the base material not incorporating the flame retardant component. Stated in another way, a “flame retardant” may increase the potential of the base material to restrict the propagation or development of flames and to reduce the developing temperature after ignition, which might result for example in a reduced dripping of the heated and burning material and/or in a reduced flame propagation. In particular a “flame retardant” according to the invention may decrease the ignition temperature of polymers or mixtures of materials containing polymers.

The “flame retardant” may also impart fire resistance, which shall be understood herein as the resistance of a material to catch fire, i.e. combust. It should be appreciated that the “flame retardant” characteristics of a base material exhibited may differ upon material construction (e.g. foam or solid material, shape, etc.) and the environment and exposure, i.e. heat intensity, degree of exposure, elemental composition of the surrounding air, etc. Furthermore, it should be understood that some base materials may inherently exhibit flame retardant characteristics.

The term “base material” refers to any kind of solid, semi-solid or liquid substrate that can be coated with a biocide according to the invention or into which a biocide can be integrated or with witch a biocide can be mixed with. Base materials preferably refer to (one or more) polymers such as thermoplastic(s) or thermoset(s); plant-based natural material(s); coating solution(s) and/or mixture(s) (e.g. composite materials) thereof.

The flammability and related properties of a base material can be detected by different methods. Each of the methods is applied for a specific purpose of the base material and defines the level of flammability. There are international and national norms which describe the flammability tests, like ISO norms 6940 and 6941, 16 CFR Part 1610, EN 103/3 and UL94, DIN EN 13501, DIN EN 13823, EN ISO 1182, DIN 4102, EN 13772, EN 13773, NF P 92-503 up to 92-505, NF P 92-507, BS 5867, BS 5438, NFPA 701. These norms define testing methods and classifications according to the results from the testing and the behavior of the base material resulting from ignition or other tests suitable to detect the flammability behavior. In a preferred embodiment of the invention the ASTM D 1929 Standard Test Method is used to assess the flammability properties of the biocides according to the invention (via the flash ignition temperature and/or the spontaneous ignition temperature). In another preferred embodiment the NF P 92-507 Standard Test Method is used to assess the flammability properties of the herein discussed biocides in combination with the herein discussed base materials.

Throughout this application common names or the chemical names of the compounds are used in accordance with the International Organization for Standardization (ISO) and always comprise all applicable forms such as acids, salts, ester, or modifications such as isomers, like stereoisomers and optical isomers.

Useful fungicides with halogen groups for the present invention include (Mode of Action of Fungicides, FRAC classification on mode of action 2011/www.frac.info) in particular

The sterol biosynthesis inhibitor (SBI) class I DMI fungicides: Triazole: Azaconazole (2 Cl atoms), Etaconazole (2 Cl atoms), Fenbuconazole (1 Cl atom), Ipconazole (1 Cl atom), Bromuconazole (2 Cl atoms, 1 Br atom), Fluquinconazole (2 Cl, 1 F atoms), Metconazole (1 Cl atom), Tebuconazole (1 Cl atom), Cyproconazole (1 Cl atom), Flusilazole (2 F atoms), Myclobutanil (1 Cl atom), Tetraconazole (4 F, 2 Cl atoms), Difenoconazole (2 Cl atoms), Flutriafol (2 F atoms), Penconazole (2 Cl atoms), Triadimefon (1 Cl atom), Diniconazole (2 Cl atoms), Hexaconazole (2 Cl atoms), Propiconazole (2 Cl atoms), Triadimenol (1 Cl atom), Epoxiconazole (1 F, 1 Cl atoms), Imibenconazole (3 Cl atoms), Prothioconazole (2 Cl atoms), Triticonazole (1 Cl atom), Simeconazole (1 F atom).

Piperazines: Triforine (6 Cl atoms); Pyridines: Pyrifenox (2 Cl atoms), Pyrisoxazole (1 Cl atom); Pyrimidines: Nuarimol (1 F, 1 Cl atom), Fenarimol (2 Cl atoms); Imidazoles: Imazalil (2 Cl atoms), Triflumizole (3 F, 1 Cl atoms), Prochloraz (3 Cl atoms), Oxpoconazole (1 Cl atom).

The sterol biosynthesis inhibitor (SBI) class II: Amines: Piperidines: Piperalin (2 Cl atoms).

The sterol biosynthesis inhibitor (SBI) class III: Hydroxyanilides: Fenhexamid (2 Cl atoms).

Mitosis and Cell Division: β-tubulin assembly in mitosis: zoxamide (3 Cl atoms); cell division: pencycuron (1 Cl atom); delocalisation of spectrin-like proteins: Fluopicolide (3 Cl, 3 F atoms).

Signal Transduction: Signal transduction: Aryloxyquinoline such as quinoxyfen (2 Cl, 1 F atoms); Quinazolinone such as proquinazid (1 I atom).

Osmotic signal transduction: Fenpiclonil (2 Cl atoms), Fludioxonil (2 F atoms), Chlozolinate (2 Cl atoms), Iprodione (2 Cl atoms), Procymidone (2 Cl atoms), Vinclozolin (2 Cl atoms).

Cell Wall Biosynthesis: Cellulose synthase: Dimethomorph (1 Cl atom), Flumorph (1 F atom), Mandipropamid (1 Cl atom), Benthiavalicarb (1 F atom), Valifenalate (1 Cl atom).

Respiration: Inhibition of Complex II, Succinate-Dehydrogenase: Penflufen (1 F atom), Furametpyr (1 Cl atom), Penthiopyrad (3 F atoms), Bixafen (3 F, 2 Cl atoms), Isopyrazam (2 F atoms), Sedaxane (2 F atoms), Fluxapyroxad (5 F atoms), Thifluzamide (6 F, 2 Br atoms), Boscalid (2 Cl atoms), Fluopyram (6 F, 1 Cl atom), Flutolanil (3 F atoms), Benodanil (1 I atom).

Inhibition of Complex I: NADH Oxido-reductase: Diflumetorim (1 Cl, 2 F atoms).

Inhibition of Complex III: cytochrome bc1: Cyazofamid (1 Cl atom); Amisulbrom (1 F, 1 Br atoms), Picoxystrobin (3 F atoms), Enoxastrobin (1 Cl atom), Pyraoxystrobin (1 Cl atom), Flufenoxystrobin (3 F atoms, 1 Cl atom), Fenaminostrobin (2 Cl atoms), Pyraclotrobin (1 Cl atom), Triclopyricarb (3 Cl atoms), Trifloxystrobin (3 F atoms), Pyribencarb (1 Cl atom), Fluoxastrobin (1 Cl, 1 F atoms).

Uncouplers of oxidative phosphorylation: Fluazinam (6 F atoms, 2 Cl atoms),

Lipid and Membrane Synthesis: Lipid Peroxidation: Tecnazene (4 Cl atoms), Dicloran (2 Cl atoms), Quintozene (5 Cl atoms), Tolclofosmethyl (2 Cl atoms), Chloroneb (2 Cl atoms), Etridiazole (3 Cl atoms).

Cell Membrane Permeability, fatty acids: Iodocarb (1 I atom).

Host Defence Inducer: Isotianil (2 Cl atoms), Tiadinil (1 Cl atom)

Melanin Synthesis in Cell Wall: Fthalide (4 Cl atoms), Carpropamid (3 Cl atoms), Diclocymet (2 Cl atoms), Fenoxanil (2 Cl atoms).

Multi Site Action: Chlorothalonil (4 Cl atoms), Anilazine (3 Cl atoms), Captan (3 Cl atoms), Captafol (4 Cl atoms), Folpet (4 Cl atoms), Dichlofluanid (2 Cl, 1 F atoms), Tolylfluanid (2 Cl, 1 F atoms).

Unknown Mode of Action: Teclofthalam (6 Cl atoms), Cyflufenamid (5 F atoms), Flutianil (4 F Atoms), Triazoxide (1 Cl atom), Flusulfamide (3 F atoms, 2 Cl atoms), Diclomezine (2 Cl atoms), Metrafenone (1 Br atom), Pyriofenone (1 Cl atom).

Useful herbicides with halogen groups for the present invention include (Mode of Action of Herbicides, HRAC classification on mode of action 2010/www.hracglobal.com) in particular

Inhibition of Photosynthesis at PS II: Bromacil (1 Br atom), Terbacil (1 Cl atom), Propazine (1 Cl atom), Terbuthylazine (1 Cl atom), Atrazine (1 Cl atom), Simazine (1 Cl atom), Trietazine (1 Cl atom), Cyanazine (1 Cl atom), Chlorobromuron (1 Cl, 1 Br atoms), Fluometuron (3 F atoms), Metobromurom (1 Br atom), Neburon (2 Cl atom), Chlorotoluron (1 Cl atom), Chloroxuron (1 Cl atom), Dimefuron (1 Cl atom), Ciuron (2 Cl atoms), Linuron (2 Cl atoms), Monolinuron (1 Cl atom), Metoxuron (1 Cl atom), Neburon (2 Cl atoms), Pentanochlor (1 Cl atom), Propanil (2 Cl atoms), Bromofenoxim (2 Br atoms), Ioxynil (2 I atoms), Bromoxynil (2 Br atoms), Pyridafol (1 Cl atom), Pyridate (1 Cl atom).

Inhibition of ALS (branched) chain amino acid synthesis: Flupyrsulfuron-methyl-sodium (3 F atoms),

Primisulfuron-methyl (4 F atoms), Trifloxysulfuron-sodium (3 F atoms), Prosulfuron (3 F atoms), Triflusulfuron-methyl (3 F atoms), Propyrisulfuron (1 Cl atom), Tritosulfuron (6 F atoms), Triasulfuron (1 Cl atom), Chlorimuron-ethyl (1 Cl atom), Flazasulfuron (3 F atoms), Halosulfuron-methyl (1 Cl atom), Chlorsulfuron (1 Cl atom), Iodosulfuron-methly-sodium (1 I atom), Imazosulfuron (1 Cl atom), Flucarbazone-sodium (3 F atoms), Pyrimisulfan (2 F atoms), Pyrithiobac-sodium (1 Cl atom), Pyroxsulam (3 F atoms), Penoxsulam (5 F atoms), Metosulam (2 Cl atoms), Florasulam (3 F atoms), Flumetsulam (2 F atoms), Diclosulam (2 Cl , 1 F atoms), Chloransulam-methyl (1 Cl, 1 F atoms),

Inhibition of Microtubule Assembly: Chlorthal-dimethyl (DCPA) (4 Cl atoms), Ethalfluralin (3 F atoms), Benefin (3 F atoms), Dinitramine (3 F atoms), Trifluralin (3 F atoms), Dithiopyr (5 F atoms), Thiazopyr (5 F atoms), Propyzamide (2 Cl atoms).

Inhibition of Microtubule organization: Chlorpropham (1 Cl atom), Falmprop-m (1 Cl, 1 F atoms).

PS-I-electron diversion: Diquat (2 Br atoms), Paraquat (2 Cl atoms).

Inhibition of Protoporphyrinogen Oxidase: Acifluorfen-sodium (3 F, 1 Cl atoms), Bifenox (2 Cl atoms), Chlormethoxyfen (2 Cl atoms), Ethoxyfen-ethyl (3 F atoms), Halosafen (4 F, 1 Cl atoms), Fluoroglycofen-ethyl (3 F, 1 Cl atoms), Lactofen (3 F, 1 Cl atoms), Oxyfluorfen (3 F, 1 Cl atoms),

Fomesafen (3 F, 1 Cl atoms), Fluazolate (4 F, 1 Cl, 1 Br atoms), Pyraflufen-ethyl (3 F, 2 Cl atoms), Cinidon-ethyl (2 Cl atoms), Flumiclorac-pentyl (1 F, 1 Cl atoms), Flumioxazin (1 F atom), Oxadiargyl (2 Cl atoms), Oxadiazon (2 Cl atoms), Azafenidin (2 Cl atoms), Bencarbazone (3 F atoms), Carfentrazone-ethyl (3 F, 2 Cl atoms), Sulfentrazone (2 Cl, 2 F atoms), Pentoxazone (1 Cl, 1 F atoms).

Inhibition of Pigment Synthesis (bleaching)/Inhibition of PDS/Inhibition of 4-HPPD: Benzofenap (2 Cl atoms), Isoxachlortole (1 Cl atom), Pyrasulfotole (3 F atoms), Isoxaflutole (3 F atoms), Pyrazoxyfen (2 Cl atoms), Pyrazolynate (2 Cl atoms), Sulcotrione (1 Cl atom), Benzobicyclon (1 Cl atom), Tefuryltrione (1 Cl atom), Tembotrione (3 F, 1 Cl atoms), Bicyclopyrone (3 F atoms).

Inhibition of PDS: Beflubutamid (4 F atoms), Diflufenican (5 F atoms), Fluridone (3 F atoms), Norflurazon (3 F, 1 Cl atoms), Flurochloridone (3 F, 2 Cl atoms), Picolinafen (3 F atoms), Flurtamone (3 F atoms).

Inhibition of Cell Division (VLCFAs): Acetochlor (1 Cl atom), Dimethachlor (1 Cl atom), Flufenacet (4 F atoms), Alachlor (1 Cl atom), Dimethenamid (1 Cl atom), Metolachlor (1 Cl atom), Butachlor (1 Cl atom), Metazachlor (1 Cl atom), Pethoxamid (1 Cl atom), Pretilachlor (1 Cl atom), Propachlor (1 Cl atom), Propisochlor (1 Cl atom), Thenylchlor (1 Cl atom), Anilofos (1 Cl atom), Pyroxasulfone (5 F atoms), Ipfencarbazone (2 F, 2 Cl atoms), Fentrazamide (1 Cl atom).

Unkown target: Fluometuron (3 F atoms), Aclonifen (1 Cl atom).

Inhibition of DOXP synthase: Clomazone (1 Cl atom).

Unknown Mode of Action: Chlorflurenol (1 Cl atom), Bromobutide (1 Br atom), Cumyluron (1 Cl atom), Etobenzanid (2 Cl atoms), Indanofan (1 Cl atom), Indanofan (1 Cl atom), Oxaziclomefone (2 Cl atoms). Lipid Synthesis Inhibition (Inhibition of ACCase): Clodinafop-propargyl (1 Cl, 1 F atoms), Cyhalofopbutyl (1 F atom), Diclofop-methyl (2 Cl atoms), Fenoxaprop-P-ethyl (1 Cl atom), Fluazifop-P-butyl (3 F atoms), Haloxyfop-P-methyl (3 F, 1 Cl atoms), Metamifop (1 Cl, 1 F atoms), Propaquizafop (1 Cl atom), Quizalofop-P-methyl (1 Cl atom), Quizalofop-P-tefuryl (1 Cl atom), Clethodim (1 Cl atom), Profoxydim (1 Cl atom), Tepraloxydim (1 Cl atom).

Lipid Synthesis Inhibition (not ACCase): Orbencarb (1 Cl atom), Thiobencarb (1 Cl atom), Tri-allate (3 Cl atoms), Dalapon (2 Cl atoms), Flupropanate (4 F atoms), TCA (3 Cl) atoms.

Inhibition of Cellulose Synthesis: Chlorthiamid (2 Cl atoms), Dichlobenil (2 Cl atoms), Flupoxam(5 F, 1 Cl atom), Triaziflam (1 F atom), Indaziflam (1 F atom).

Synthetic Auxins: Aminopyralid (2 Cl atoms), Chlopyralid (2 Cl atoms), Fluroxypyr (2 Cl, 1 F atoms), Picloram (3 Cl atoms), Triclopyr (3 Cl atoms), Chloramben (2 Cl atoms), Dicamba (2 Cl atoms), TBA (3 Cl atoms), Quinclorac (2 Cl atoms), Quinmerac (1 Cl atom), 2,4-D (2 Cl atoms), Clomeprop (2 Cl atoms), Mecoprop (1 Cl atom), 2,4-DB (2 Cl atoms), Dichlorprop (2 Cl atoms), MCPA (1 Cl atom), MCPB (1 Cl atom), Benazolin-ethyl (1 Cl atom).

Auxin Transport Inhibition: Diflufenzopyr-sodium (2 F atoms).

Useful plant growth regulators include Cyclanilide (2 Cl atoms), ethephon (1 Cl atom).

Useful safeners according to the invention include Mefenpyr-diethyl (2 Cl atoms).

Useful insecticides with halogen groups for the present invention include (Mode of Action of Insecticides, IRAC classification on mode of action 2012/www.irac-online.org) in particular

Acetylcholinesterase (AChE) Inhibitors: Organophosphates: Profenofos (1 Br, 1 Cl atoms), Chloropyrifos (3 Cl atoms).

GABA-gated chloride channel antagonists: Fiproles: Ethiprole (3 F, 2 Cl atoms), Fipronil (6 F, 2 Cl atoms).

Sodium Channel Modulators: Pyrethroids: Bifenthrin (3 F atomes), Cyfluthrin (2 Cl, 1 F atoms), Beta-Cyfluthrin (2 Cl, 1 F atoms) Cypermethrin (2 Cl atoms), Alpha-cypermethrin (2 Cl atoms), Zeta-cypermethrin (2 Cl atoms), Deltamethrin (2 Br atoms), Esfenvalerate (1 Cl atom), Lambda-cyhalothrin (3 F atoms), Tefluthrin (7 F atoms), Spirodiclofen (2 Cl atoms), Silafluofen (1 F atom), Tralomethrin (3 Br atoms), Transfluthrin (4 F, 2 Cl atoms).

Others: Methoxychlor (3 Cl atoms), DDT (5 Cl atoms).

Nicotinicacetylcholine receptor (nAChR) agonists: Neonicotinoids: Acetamiprid (1 Cl atom), Clothianidin (1 Cl atom), Imidacloprid (1 Cl atom), Nitenpyram (1 Cl atom), Thiacloprid (1 Cl atom), Thiamethoxam (1 Cl atom),

Others: Sulfoxaflor (3 F atoms).

Miscellaneous non-specific (multi-site) inhibitors: Chloropicrin (3 Cl), Sulfuryl fluoride (2 F atoms).

Selective Homopteran Feeding Blockers: Flonicamid (3 F atoms)

Mite Growth Inhibitors: Clofentezine (2 Cl atoms), Hexythiazox (1 Cl atom), Etoxazolee (2 F atoms).

Inhibitors of mitochondrial ATP synthase: Tetradifon (4 Cl atoms).

Uncouplers of Oxidative Phosphorylation via Disruption of Proton Gradient: Chlorfenapyr (1 Cl, 1 Br, 3 F atoms), Sulfluramid (17 F atoms).

Inhibitors of Chitin Biosynthesis: Bistrifluron (8 F, 1 Cl atoms), Chlorfluazuron (5 F, 3 Cl atoms), Diflubenzuron (1 Cl, 2 F atoms), Flucycloxuron (1C1, 2 F atoms), Flufenoxuron (6 F, 1 Cl atoms), Hexaflumuron (2 Cl, 6 F atoms), Lufenuron (2 Cl, 8 F atoms), Novaluron (1 Cl, 8 F atoms), Noviflumuron (2 Cl, 9 F atoms), Teflubenzuron (4 F, 2 Cl atoms), Triflumuron (3 F, 1 Cl atoms).

Ecdysone Receptor Agonists: Halofenozide (1 Cl atom).

Mitochondrial Complex III Electron Transport Inhibitors: Hydramethylnon (6 F atoms), Fluacrypyrim (3 F atoms).

Mitochondrial Complex I Electron Transport Inhibitors: Pyridaben (1 Cl atom), Pyrimidien (1 Cl atom), Tebufenpyrad (1 Cl atom), Tolfenpyrad (1 Cl atom).

Voltage-Dependent Sodium Channel Blockers: Indoxacarb (1 Cl, 3 F atoms), Metaflumizone (6 F atoms). Mitochondrial Complex II Electron Transport Inhibitors: Cyflumetofen (3 F atoms).

Ryanodine Receptors Modulators: Chlorantraniliprole (2 Cl, 1 Br atoms), Cyantraniliprole (1 Cl, 1 Br atoms), Flubendiamide (7 F, 1 I atoms).

Unknown/Uncertain Mode of Action: Cryolite (6 F atoms), Pyridalyl (4 Cl, 3 F atoms), Benzoximate (1 Cl atom), Dicofol (5 Cl atoms), Pyrifluquinazon (7 F atoms), Niclosamid (2 Cl atoms).

Others: Sivanto (BYI 2960) (2 F, 1 Cl atom).

Useful nematicides according to the invention include carbamate nematicides: cloethocarb (1 Cl atom); organophosphate nematicides: phosphamidon (1 Cl atom), chlorpyrifos (3 Cl atoms), dichlofenthion (2 Cl atoms), isazofos (1 Cl atom); unclassified nematicides: acetoprole (3 F, 2 Cl atoms), benclothiaz (1 Cl atom), chloropicrin (3 Cl atoms), DBCP (2 Br, 1 Cl atoms), DCIP (2 Cl atoms), fluensulfone (3 F, 1 Cl atoms).

Useful rodenticides according to the invention include coumarins/4-hydroxycoumarins: brodifacoum (1 Br atom), flocoumafen (3 F atoms) and bromadiolone (1 Br atom); 1,3-indandiones: chlorophacinone (1 Cl atom); others: difethialone (1 Br atom).

In a preferred embodiment of the invention the biocide used as a flame-retardant is an insecticide as described above. In an even more preferred embodiment of the invention the insecticide is not classified as a toxicity class 1 compound according to the US Environmental Protection Agency toxicity classification system.

In another preferred embodiment of the invention a biocide is used as a flame-retardant which is selected from the group of Bixafen, Cyproconazole, Cyantraniliprole, Fluopicolide, Fluopyram, Isotianil, Penflufen, Prothioconazole, Tebuconazole, Trifloxistrobin, Fenhexamid, Fluoxastrobin, Fluquinconazole, Triadimenol, Pencycuron, Triadimefon, Flufenacet, Indaziflam, Mefenpyr-Diethyl, Pyrasulfotole, Tembotrione, Tefuryltrione, Aclonifen, Bromoxynil, Diflufenican, Fenoxaprop-P-ethyl, Fentrazamide, Flurtamone, Iodosulfuron-methyl-sodium, Cyclanilide, Ethephon, Ioxynil, Metosulam,

Oxadiargyl, Oxadiazon, Lactofen, Flubendiamide, Thiacloprid, Ethiprole, Beta-cyfluthrin, Imidacloprid, Deltamethrin, Fipronil, Spirodiclofen, Triflumuron, Cyfluthrin, Silafluofen, Tralomethrin, Niclosamid, Cypermethrin, Sivanto (BYI 2960) Chlothianidin and/or Transfluthrin.

In another preferred embodiment of the invention a biocide is used as a flame-retardant that is selected from the group of: Bixafen, Cyproconazole, Cyantraniliprole, Fluopicolide, Fluopyram, Isotianil, Prothioconazole, Tebuconazole, Fenhexamid, Fluoxastrobin, Fluquinconazole, Triadimenol, Pencycuron, Triadimefon, Tembotrione, Tefuryltrione, Aclonifen, Bromoxynil, Fenoxaprop-P-ethyl, Fentrazamide, Iodosulfuron-methyl-sodium, Cyclanilide, Ethephon, Ioxynil, Metosulam, Oxadiargyl, Oxadiazon, Lactofen, Flubendiamide, Thiacloprid, Ethiprole, Beta-cyfluthrin, Imidacloprid, Deltamethrin, Fipronil, Spirodiclofen, Triflumuron, Cyfluthrin, Tralomethrin, Niclosamid, Cypermethrin, Sivanto (BYI 2960), and Chlothianidin and/or Transfluthrin.

In a further particularly preferred embodiment of the invention a biocide is used as a flame-retardant that is selected from the group of: Beta-cyfluthrin, Bromoxynil, Cyantraniliprole, Deltamethrin, Chlothianidin.

In the most preferred embodiment of the invention Deltamethrin is used as flame-retardant.

The molecular halogen content (MHG) is described via the formula: MHG=sum of Molar masses of all halogen atoms in molecule [g/mol]/sum of Molar masses of all atoms in the molecule [g/mol]*100%.

Known flame-retardants (which are not biocides) such as HBCD (Hexabromcyclododecan) DecaBDE (Decabromdiphenylether), brominated Polystyrole (2.4.6-Tribromphenol), TBBPA (Tetrabrombisphenol A), DecaBDE (Decabromdiphenylether), PentaBDE, TBBPA-Ester, Octabromodiphenyl ether (Octa BDE), Tribromneopentylalkohol, 1,2-Dibrom-bis-pentabromphenylethan have molecular halogen contents (MHG) of between 59-83%.

Mirex, Endosulfan, Dieldrin, Endrin, Chlordane and Aldrin have molecular halogen contents of between 52-78%.

In light of the above, it has been surprisingly found that the herein discussed preferred biocides with a halogen content in relation to the molecular weight of the molecule (molecular halogen content in %) of less than 52% can also be used as flame-retardants. In a preferred embodiment of the invention the molecular halogen content (MHG) of the used biocide is between 10-50%, preferably between 14-42% and more preferably between 20-40%.

The molecular halogen content (MHG) of the biocide is related to the amount needed for developing the flame retardant properties.

The dual functionality of the biocides according to the invention make them useful for various applications in particular together with other base materials such as polymers, plant-based materials, coating solutions and/or mixtures thereof. Another advantage as compared to compounds having chlorinated norbornene moiety is their reduced toxicity profile.

Gaseous biocides are not usable together with a base material. Liquid biocides can be used as flame-retardants for polymers such as e.g. polyurethane foams, which are produced from liquid monomers (e.g. polyols and isocyanates) or for coating solutions respectively coatings of a base material (e.g. water- or solvent-based polymer dispersions and organic, natural-based coatings, like oils, fats, natural resins etc.).

Most of the biocides are solid. They easily can be added during processing of the polymeric material. As the processing temperatures of common polymers such as thermoplastics are in a range of 130-320° C. (e.g. extrusion, compounding, film blowing, spinning, calendaring, foaming etc.), some of the biocides might melt during processing as well and are solidifying together with the matrix polymer during cool-down giving a homogenous material compound containing the desired amount of biocide. The addition of the biocide can also be done in a two-step process, with a concentrate (masterbatch) produced via mixing of the polymer with the biocide and a second processing step where the biocide is further diluted by adding additional polymers during processing. In the case of polyurethane foam, the biocide can be added to the monomers which react during processing to give a polymeric foam containing the desired amount of biocide. In the case of plant-based materials, the biocide can be added by coating a coating solution onto the plant-based material or soaking a plant-based material into a biocide containing coating solution.

Base Materials

The biocides of the present invention are particularly useful together with a base material, preferably a polymer such as a thermoplastic or thermoset; plant-based material; coating solution and/or mixtures thereof whenever the polymer, plant-based material, composite material and/or a surface onto which the coating solution is applied to (which is again a substrate/base material e.g. cardboard, paper, wood, insulation material surface etc.) needs to be protected against fire and harmful organisms.

According to the present invention polymers include synthetic polymers such as thermoplastics or thermosets. Thermoplastics, also known as a thermosoftening plastics, are polymers that turn to liquid when heated and freeze to a rigid state when cooled sufficiently. Most thermoplastics are high-molecular-weight polymers whose chains associate through weak Van der Waals forces (e.g. polyethylene); stronger dipole-dipole interactions and hydrogen bonding (e.g. nylon) or even stacking of aromatic rings (e.g. polystyrene). Thermoplastic polymers differ from thermosetting polymers (e.g. phenolics, epoxies) in that they can be remelted and remoulded. Many thermoplastic materials are addition polymers; e.g. vinyl chain-growth polymers such as polyethylene and polypropylene; others are productions of condensation or other forms of polyaddition polymerisation, such as the polyamides or polyester. Polymers such as thermoplastics and rubber polymers can be selected from the group of Acrylonitrile Butadiene Styrene (ABS), Acrylic (PMMA), Celluloid, Cellulose acetate, Cyclic Olefin Copolymer (COC), Ethylene-Vinyl Acetate (EVA), Ethylene Vinyl Alcohol (EVOH), Fluoroplastics (PTFE, alongside with FEP, PFA, CTFE, ECTFE, ETFE), Ionomers, Liquid Crystal Polymer (LCP), Polyoxymethylene (POM or Acetal), Polyacrylates (Acrylic), Polyacrylonitrile (PAN or Acrylonitrile), Polyamide (PA or Nylon), Polyamide-imide (PAI), Polyaryletherketone (PAEK or Ketone), Polybutadiene (PBD), Polybutylene (PB), Polybutylene Terephthalate (PBT), Polycaprolactone (PCL), Polychlorotrifluoroethylene (PCTFE), Polyethylene Terephthalate (PET), Polycyclohexylene dimethylene Terephthalate (PCT), Polycarbonate (PC), Polyhydroxyalkanoates (PHAs), Polyketone (PK), Polyester, Polyethylene (PE), Polyetheretherketone (PEEK), Polyetherketoneketone (PEKK), Polyetherimide (PEI), Polyethersulfone (PES), Chlorinated Polyethylene (CPE), Olyimide (PI), Polylactic Acid (PLA), Polymethylpentene (PMP) , Polyphenylene Oxide (PPO), Polyphenylene Sulfide (PPS), Polyphthalamide (PPA), Polypropylene (PP), Polystyrene (PS), Polysulfone (PSU), Polytrimethylene terephthalate (PTT), Polyurethane (PU), Polyvinyl Acetate (PVA), Polyvinyl Chloride (PVC), Polyvinylidene Chloride (PVDC), Styrene-acrylonitrile (SAN).

Polymers that contain halogenized monomers, as for example Polycinyl chloride (PVC) and Polytetrafluorethylene (PTFE), but also Polydibromstyrene or similar polymers have inherently flame retardant properties. These polymers can also be treated with the flame-retardant biocides in order to further strengthen the anti-flammability properties.

In a preferred embodiment of the invention, however, the biocides of the invention are used as flame-retardants in base materials (and in particular polymers) or on base materials (and in particular polymers) that do not comprise halogens.

In another preferred embodiment of the invention, the biocides of the invention are used as flame-retardants in polymers selected from the group of polyester, polyamide, polyethylene, polypropylene (preferred is polypropylene), more preferably from polypropylene (PP) and polyethylene (preferably HDPE, LDPE and LLDPE, with Metallocene- and Ziegler-Natta types included). The concentration of the biocide in (respectively on) the polymer can be varied within a relatively wide concentration range (for example from 1% to 15% by weight). The concentration should be chosen according to the field of application such that the requirements concerning efficacy, desired flame-retardant properties durability and toxicity are met.

According to the present invention the term “thermoset” refers to a thermosetting plastic which is polymer material that irreversibly cures. The cure may be done through heat (generally above 200° C. (392° F.)), through a chemical reaction (two-part epoxy, for example), or irradiation such as electron beam processing. Thermoset materials are usually liquid or malleable prior to curing and designed to be molded into their final form, or used as adhesives. Others are solids like that of the molding compound used in semiconductors and integrated circuits (IC). Once hardened a thermoset resin cannot be reheated and melted back to a liquid form. According to IUPAC recommendation: A thermosetting polymer is a prepolymer in a soft solid or viscous state that changes irreversibly into an infusible, insoluble polymer network by curing. Curing can be induced by the action of heat or suitable radiation, or both. A cured thermosetting polymer is called a thermoset. Some examples of thermosets are: Polyester fibreglass systems (sheet molding compounds and bulk molding compounds); vulcanized rubber; bakelite, a phenol-formaldehyde resin; duroplast; urea-formaldehyde foam; melamine resin; epoxy resin; polyimides; cyanate esters or polycyanurates.

The term “plant-based natural materials” refers to natural derived substrates/fibers such cellulose-based materials (paper/cardboard), cotton, sisal, wood, flax, cotton, bamboo, hemp, wool etc.

For the production of polymers such as thermoplastics, thermosets or composite materials and mixtures thereof (e.g. thermoplastics mixed with other thermoplastics or e.g. thermoplastics with plant-based natural materials) additional additives can be used such as e.g. metal deactivators, peroxide scavengers, basic costabilizers, nucleating agents, plasticizers, lubricants, UV-protecting agents, emulsifiers, pigments, viscosity modifiers, catalysts, flow control agents, optical brighteners, antistatic agents and blowing agents, benzofuranones and indolinones, fluorescent plasticizers, mould release agents, additional flame-retardant additives, synergists, antistatic agents such as sulphonate salts, pigments and also organic and inorganic dyes and also compounds containing epoxy groups or anhydride groups.

The term “coating solution”, as used herein, shall refer to a solution that is later sprayed to form a coating, or a part of a coating, and include the herein discussed biocides as well as other coating solution components such as but not limited to solvents, polymers, oils, fats, natural resins, tensides, surfactants, emulgators, stabilizers, salts thickeners, fragrants, pigments and/or other additives. Coating solutions are preferably liquid at room temperature (25° C.).

According to the present invention the term “coatings” refers to a coating solution that is applied to the surface of an object, usually referred to as the substrate (which can also be a base material). In the context of the present invention, coatings (e.g. in the form of a paint or varnish) are applied to improve surface properties of the substrate (base material), such as in particular the flammability properties and—at the same time—to protect a surface against the infestation of the surface of a harmful organisms, and/or alternatively to efface harmful organisms from the surface. Therefore, in such an application the coating forms an essential part of the finished product (the coating functions as a material protection for the product on which it was applied to).

In another preferred embodiment the biocide of the invention is preferably used with the base material in a concentration of below 50 weight percent (wt %), preferred below 32 wt %, and even more preferred below 20 wt %. In a further preferred embodiment the concentration of the biocide (as used together with a base material) is between 0.4 to 8 wt %, preferably 0.5 to 3 wt % and even more preferably from 0.5 to 1 wt % (the combination of the biocide and the base material equals 100 wt %).

Products Made from Base Materials

The polymers of the present invention can be processed into miscellaneous products such as for example, foams, foils, pellets, plates, air-cushioning materials, films, bed nets (mosquito nets), profiles, sheets, textiles, wires, threads, tapes, cable and pipe linings, casings for electrical instruments (for example in switch boxes, aircraft, refrigerators, etc.) Further examples are given herein below.

The polymers with biocides and in particular with insecticides according to the invention as well as the threads, fibers, wovens, nets (bed nets), etc. produced therefrom are very useful for killing harmful or annoying arthropods, more particularly arachnids and insects. The manufacturing of such products is described in detail in e.g. WO2009/121580, WO2011/128380, WO2011/141260.

The polymers with the biocides and in particular with rodenticides according to the invention and profiles, sheets, foils, wires, threads, tapes, cable and pipe linings etc. produced therefrom are very useful for killing harmful and biting animals, like rodents (mice, rats) and martens. Example of such products are e.g. soil films with rodenticides/insecticides for rodent and/or ant control or plastic parts for use in cars.

The benefit of the use of the biocides according to the invention (in particular fungicides, herbicides, nematicides, rodenticides and/or insecticides) is also of particular interest in connection with foams made from polymers (such as polyurethane foams or expandable polystyrene foams) e.g. used as insulating material for buildings in order to protect the insulation material from living species (rodents, nematodes, insects, maggots etc.), fungae and/or attack from herbals and plants. At the same the biocides act as flame retardants in order to limit/decrease the fire risk of such insulating materials.

Polymers as well as plant-based materials together with the biocides of the invention can also be used to produce textiles. According to the present invention the term “textiles” is referring to a textile or cloth that is a flexible woven material consisting of a network of natural or artificial fibres often referred to as thread or yarn. Yarn is produced by spinning raw fibres of a plant-based material such as wool, flax, cotton, hemp, or other materials such as polymers to produce long strands. Textiles are formed by weaving, knitting, crocheting, knotting, or pressing fibres together.

Further products which can be made with the discussed base materials or onto which the coating solutions of the invention can be applied include e.g. outdoor carpetings, outdoor furniture, window shades, curtains, outdoor coverings for tables, and other flat surfaces, patio decks, hulls, filtering, flags, backpacks, tents, nets, mosquito nets, transportation devices such as balloons, kites, sails, and parachutes; technical textiles such as geotextiles (reinforcement of embankments), agrotextiles (textiles for crop protection such as horticulture films), protective clothing, electrical insulation, insulation for buildings etc.

In a preferred embodiment of the invention the biocides as discussed herein are used as flame-retardants:
for polymeric textiles and polymeric mosquito nets (for such applications the polymeric textile, mosquito net is preferably made of polypropylene or polyethylene (preferably polypropylene) and the biocide is preferably an insecticide and more preferably a pyrethroid and even more preferably deltamethrin),
for polymeric insulations of buildings (for such an application the biocide is preferably a herbicide, insecticide, nematicide, rodenticide and/or a fungicide),
For polymeric profiles, sheets, foils, wires, threads, tapes, cable and pipe linings with a rodenticide and/or an insecticide.
in coating solutions in particular for the protection of wood (for applications on wood the biocide is preferably an insecticide e.g. in order to protect the wood against a termite attack),
coating solutions for vector control applications (such as to impregnate mosquito nets, indoor residual sprays or space sprays; for such applications the biocide is preferably an insecticide).

In a particularly preferred embodiment of the invention Deltamethrin is used as a flame retardant with a base material wherein the base material is polypropylene and wherein polypropylene and Deltamethrin are processed to a mosquito net resulting in the incorporation of Deltamethrin into the fibers of the mosquito net.

Mosquito nets having multifilament fibers (preferably from 1 to 100, more preferably from 10 to 60 filaments) are particularly useful in combination with the herein discussed biocides (and in particular with Deltamethrin). Particularly preferred are also mosquito nets with fibers having a linear density of 1000 to 10 denier, preferably 500 to 20 denier and more preferably 200 to 50 denier. The concentration of the biocide in the mosquito net is preferably in the range from 0.4 to 8 wt %, preferably 0.5 to 3 wt % and even more preferably from 0.5 to 1 wt %. The base material (preferably polypropylene) is preferably present in the range of between 98.5 to 99.5 wt % of the mosquito net. Other components of the mosquito nets are preferably present in the range of between 0 to 0.5 wt % and are e.g. additives such as UV stabilizer, spin finish, metal deactivators, peroxide scavengers, basic co-stabilizers, nucleating agents, plasticizers, lubricants, emulsifiers, pigments, etc. (but preferably no additional flame-retardant additives). All weight percent which refer to the mosquito net of the above-described components give not more than 100% in total. The manufacturing of mosquito nets is described in detail in e.g. WO2011/128380, WO2011/141260.

In another preferred embodiment the NF P 92-507 Standard Test Method is used to assess the flammability properties of the above discussed preferred mosquito net.

The term “vector control” according to the present invention refers to the field of eradication of arthropods such as insects and more preferably mosquitos which transmit disease pathogens (in particular plasmodium malaria and dengue virus).

A particular advantage of the present invention is that the dual activity of the biocides according to the invention allows to avoid the deployment of two different compounds (a flame retardants and a biocide). This is particularly useful as the costs of goods of a certain product can be reduced. In addition, the toxicological profile of a product can also be better assessed as only one compound needs to be used. As the safety of the above indicated biocides is relatively well known, the toxicological profile of a product can be assessed earlier and with better accuracy.

Another embodiment of the invention relates to the use of a biocide according to the invention to decrease the combustibility of a mosquito net that does not comprise a flame-retardant in comparison to a mosquito net that does comprise neither a flame-retardant nor a herein discussed biocide. Another embodiment of the invention relates to a method to decrease the combustibility of a mosquito net or an insulation for buildings (preferably a mosquito net) that does not comprise a flame-retardant with a biocide according to the invention.

Another embodiment of the present invention is a method to use a biocide as discussed herein above as a flame-retardant.

### EXAMPLES

ASTM D 1929: Standard Test Method for Determining Ignition Temperature of Plastics

The objective of this method is to determine at which temperature plastic material (sheet or granules) release flammable gases and vapors to such an extent, that an explosive mixture with air can be formed, that can be ignited with a pilot flame.

This “flash-point” of plastics is an important safety characteristic, which can be used to assess explosion and fire risk in plant where plastic material is processed, handled or stored. The objective of this method is to determine the temperature at which gases and vapors released from plastic sheets or granules spontaneously catch fire, i.e. without contact to an external ignition source. The Self-Ignition Temperature is relevant for the assessment of ignition risks due to hot surfaces in plant where plastic material is processed, e.g. in extruders. The tests are carried out by exposing the test item (sample) in an oven to a controlled stream of hot, fresh air. Ignition is detected by monitoring the temperature of the sample. For flash ignition, a pilot flame above the exhaust of the oven is used. For self-ignition test, no external ignition source is applied. The test are carried out in isothermal mode, i.e. at constant temperature. Several trials, at different temperatures are necessary to find the lowest temperature, at which ignition does occur.

ASTM D 1929 Test Results with Polypropylene Beads with and without Deltamethrin

Pure polypropylene beads (Basell, PP Metocene HM 562 S) were compared with polypropylene beads (Basell, PP Metocene HM 562 S) comprising 11 wt % Deltamethrin and 2 wt % Bumetrizole with the ASTM D 1929 test method. The polypropylene beads with Deltamethrin were manufactured via extrusion with a compounding extruder at a temperature of 180° C. Different air temperature of between 310 up to 420° C. were applied to the test samples. An air velocity of 25 (mm/s) was chosen for the test. Flash and spontanous ignition was observed at the different air temperatures and melting time was measured for the different test samples.

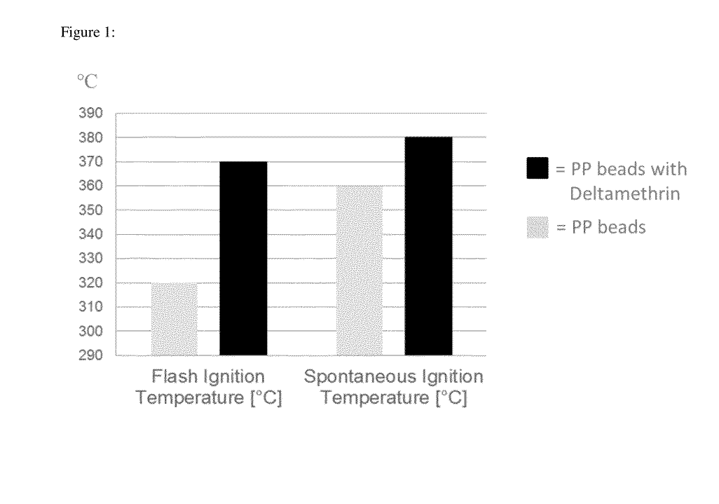

The results are shown in FIG. 1. The light grey bars show the flash ignition temperature and spontaneous ignition temperature of the polypropylene beads alone. The black bars show the flash ignition temperature and spontaneous ignition temperature of the polypropylene beads with Deltamethrin. From these results it can be seen that beads with Deltamethrin have a higher flash ignition temperature as well as a higher spontaneous ignition temperature which can be traced back to the flame retardant properties of Deltamethrin.

ASTM D 1929 Test Results with Polymeric Solids with embedded Biocides

To prepare the polymer samples with biocides, an amount of 9 g of polymer (Polypropylene Basell, PP Metocene HM 562 S or Polyethylene Exxon LLDPE) were mixed with 1 g of biocides (either Deltamethrin, Beta-Cyfluthrin, Cyantraniliprole or Bromoxynil) and the solvent (35 ml Xylene) in a flask, and heated in an oil bath to 145° C. for Polypropylene and 135° C. for Polyethylene with reflux cooler. In the case for Clothianidin, 9.25 g of polymer were mixed with 0.75 g Clothianidin and the solvent (35 ml Xylene).

The solids are then dissolved by stirring the mixture 20 min after reaching the temperature indicated. After the mixture is homogenized, the mixture was let cooled down until a gel-type mixture was formed, then put into a crystallization bowl and let it dry at room temperature overnight. From the remaining solid, the residual Xylene was evaporated in a rotary evaporator for 2 hours at a temperature of 56° C. and vacuum of 5-7 mbar.

To compare the pure PP and PE polymers, untreated granules of PP and PE were taken as received from the suppliers. These samples are named “PP untreated” and “LLDPE untreated”.

To compare the effect of the possible inclusion of the solvent, comparative samples of polypropylene and polyethylene were also prepared in the same way as the polymers with biocides, but without any addition of biocides. These blank samples are prepared mixing an amount of 10 g of polymer (Polypropylene Basell, PP Metocene HM 562 S or Polyethylene Exxon LLDPE) with the solvent (35m1 Xylene) in a flask, and extract the solvent again with the same procedure as described above. These samples are named “PP blank” and “LLDPE blank”. The results of these experiments are depicted in

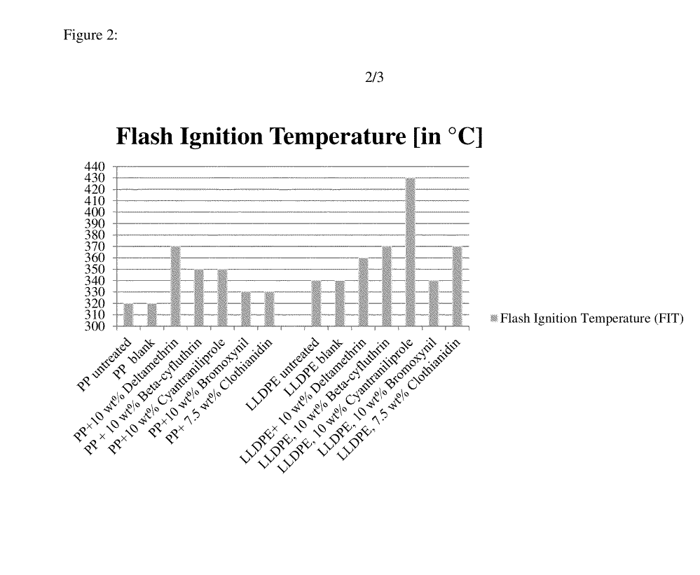

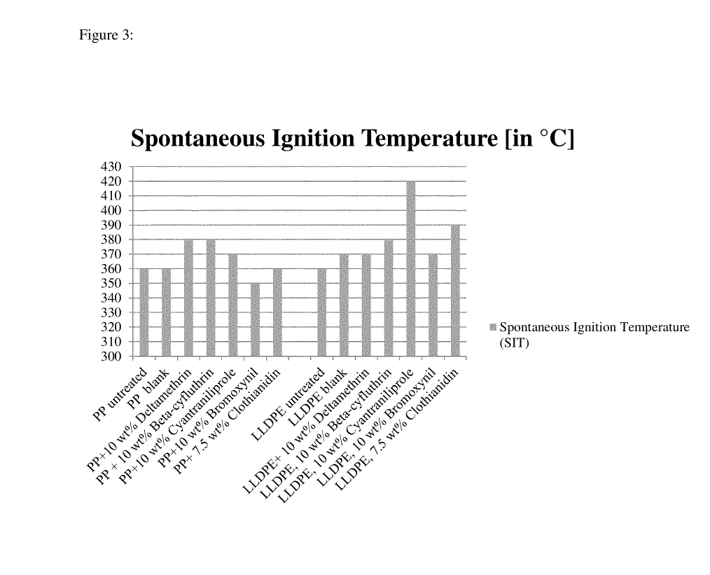

FIG. 2 (Flash Ignition Temperature data) and FIG. 3 (Spontaneous Ignition Temperature data). The results show that biocides according to the invention are useful as flame retardants because beads with such biocides have a higher flash ignition temperature as well as a higher spontaneous ignition temperature in comparison to beads that do not comprise such biocides (PP blank and PP untreated respectively LLDPE blank and LLDPE untreated).

Flammability M classification of polymeric base materials with coated/embedded insecticides according to the ISO norm NF P 92-507 of flammability ratings.

Flammability characteristics of a mosquito net produced according to WO2011/128380 and WO2011/141260 (LifeNet® from Bayer, 0.85% w/w Deltamethrin incorporated into 99.15% w/w polypropylene fibers) was compared with OlysetNet®, a mosquito net from Sumitomo Chemical (2.0% w/w Permethrin incorporated into polyethylene) and Permanet®2.0 (polyester fibers treated with Deltamethrin) were measured according to the (French) category NF P 92-507 of flammability ratings. LifeNet® was rated M1, which is the highest standard for flammability in material according to the M classification of fabrics. OlysetNet® and Permanet®2.0 were rated M4 (lowest rating within this classification). This results is surprising. In particular in light of the fact that a person skilled in the art knows that the melting point of polypropylene is lower than that of polyester (while, however, it is known that the flame retardancy properties as tested with the method UL94 are similar between Polypropylene, Polyethylene and Polyester (Saechtling Kunststofftaschenbuch, 28. Ausgabe 28, pages 403, 430 and 506)). This example indicates that when Deltamethrin is incorporated into polypropylene

(LifeNet®) even better flammability characteristics can be achieved in comparison to polyester fibers treated with Deltamethrin (Permanet®2.0) or polyethylene fibers where Permethrin has been incorporated (OlysetNet®).

1. A biocide comprising at least one halogen moiety wherein said biocide is being used as a flame retardant,. with the proviso that the biocide is not selected from the group of Mirex, Endosulfan, Dieldrin, Endrin, Aldrin, Chlordane, Dicamba, Lindane, MCPA, 1,3-dichloropropene, a substituted urea compound containing at least one 2,2,2-trichloro-1-hydroxyethyl group and a halogenated aryl di-ester compound of phosphoric acid.

2. A biocide pursuant to claim 1, wherein the biocide is selected from the group of insecticides, fungicides, herbicides, rodenticides, and/or nematicides.

3. A biocide pursuant to claim 1, wherein the biocide is an insecticide.

4. A biocide pursuant to claim 3 wherein the insecticide is not classified as a toxicity class 1 compound according to the US Environmental Protection Agency toxicity classification system.

5. A biocide pursuant to claim 1, wherein the biocide has a molecular halogen content in relation to the molecular weight of the biocide of from 10% to 50%.

6. A biocide pursuant to claim 1 together with a base material.

7. A biocide pursuant to claim 6, wherein the base material is selected from the group of one or more polymer(s), plant-based natural material(s), coating solution(s) and/or mixture(s) thereof.

8. A biocide pursuant to claim 6 wherein the biocide is used together with a base material and the base material
a. is a polymer in form of/or processed into a textile, mosquito net, insulation for buildings, profile, sheet, foil, wire, threads, tape, cable or pipe linings, or
b. is a coating solution for vector control or wood protection.

9. A biocide pursuant to claim 1, wherein the biocide is Deltamethrin, Beta-cyfluthrin, Cyantraniliprole, Bromoxynil and/or Clothianidin.

10. A biocide pursuant to claim 9 wherein the biocide is Deltamethrin.

11. A biocide pursuant to claim 8 wherein the base material
a. is a polymer in the form of/or processed into a mosquito net and wherein the polymer is polypropylene or polyethylene.
b. is a polymer in the form of/or processed into an insulation for buildings wherein the polymer is a polyurethane and/or a polystyrene foam.

12. A method to decrease combustibility of a mosquito net or an insulation for a building that does not comprise a flame-retardant comprising applying a biocide as described in claim 1 to said net or insulation.

13. A biocide pursuant to claim 9 as a flame retardant with a base material, wherein the base material is a polymer and the polymer is polypropylene, polyethylene, polyamide and/or polyester.

14. Deltamethrin as a flame retardant with a base material wherein the base material is a polymer and the polymer is polypropylene or polyethylene, preferably polypropylene.

15. Deltamethrin as a flame retardant with a base material according to claim 14 wherein the base material is polypropylene and wherein polypropylene and Deltamethrin are processed to a mosquito net resulting in incorporation of Deltamethrin into fibers of the mosquito net.
